(19) United States
(12) Patent Application Publication
(10) Pub. No.: US 2015/0013747 A1
(43) Pub. Date: Jan. 15, 2015

(54) SINTERING OF DYE-SENSITISED SOLAR CELLS USING METAL PEROXIDE

(71) Applicant: BANGOR UNIVERITY, Bangor (GB)

(72) Inventors: Peter Holliman, Conwy (GB); Dhiyaa Al-Husenawi, Bangor (GB); Arthur Connell, Bangor (GB); Eurig Jones, Holyhead Anglesey (GB)

(73) Assignee: BANGOR UNIVERSITY, Bangor (GB)

(21) Appl. No.: 14/377,336

(22) PCT Filed: Feb. 11, 2013
(86) PCT No.: PCT/GB2013/050308

§ 371 Date: Aug. 7, 2014

(30) Foreign Application Priority Data
Feb. 10, 2012 (GB) 1202307.3

(51) Int. Cl. H01G 9/20

(52) U.S. Cl. CPC H01G 9/2031; H01G 9/2059; H01G 9/2036
USPC 136/244; 438/82

(57) ABSTRACT

This invention relates to the field of dye-sensitised solar cells and to a method for reducing the temperature necessary for sintering the metal oxide paste coating the electrode by adding a metal peroxide to the metal oxide paste coated to the electrode.

### FIELD OF THE INVENTION

This invention relates to the field of dye-sensitised solar cells and to a method for reducing the temperature necessary for sintering the metal oxide paste coating the electrode.

### DESCRIPTION OF THE RELATED ART

Solar cells are traditionally prepared using solid state semiconductors. Typical solar cell crystals are prepared from silicon because photons having frequencies in the visible light range have enough energy to take electrons across the band-gap between the low energy levels and the conduction band. One of the major drawbacks of these solar cells is that the most energetic photons in the violet or ultra-violet frequencies have more energy than necessary to move electrons across the band-gap; resulting in considerable waste of energy that is merely transformed into heat. Another important drawback is that the p-type layer must be sufficiently thick in order to have a chance to capture a photon, with the consequence that the freshly extracted electrons also have a chance to recombine with the created holes before reaching the p-n junction. The maximum reported efficiencies of the silicon-type solar cells are thus of 20 to 25% or lower for solar cell modules, due to losses in combining individual cells together.

Another important problem of the silicon-type solar cell is the cost in terms of monetary price and also in terms of embodied energy, that is the energy required to manufacture the devices.

Another type of solar cells, the dye-sensitised solar cells (DSSC) have been developed in 1991 by O'Regan and Gratzel (O'Regan B. and Gratzel M., in Nature, 1991, 353, 737-740). They are produced using low cost material and do not require complex equipment for their manufacture. They separate the two functions provided by silicon: the bulk of the semiconductor is used for charge transport and the photoelectrons originate from a separate photosensitive dye. The cells are sandwich structures as represented in FIG. 1.

In these cells, photons strike the dye moving it to an excited state capable of injecting electrons into the conducting band of the titanium dioxide from where they diffuse to the anode. The electrons lost from the dye/TiO₂ system are replaced by oxidising the iodide into triiodide at the counter electrode, whose reaction is sufficiently fast to enable the photochemical cycle to continue.

The DSSC generate a maximum voltage comparable to that of the silicon solar cells, of the order of 0.7 V. An important advantage of the DSSC, as compared to the silicon solar cells, is that they inject electrons in the titanium dioxide conduction band without creating electron vacancies nearby, thereby preventing quick electron/hole recombinations. They are therefore able to function in low light conditions where the electron/hole recombination becomes the dominant mechanism in the silicon solar cells. The present DSSC are however not very efficient in the lower part of the visible light frequency range in the red and infrared region, because these photons do not have enough energy to cross the titanium dioxide band-gap or to excite most traditional ruthenium bipyridyl dyes.

They suffer however from the major disadvantage of requiring a very high temperature of about 450° C. for sintering the metal oxide paste. Another drawback of the dye-sensitised solar cells lies in the long time necessary to dye the titanium dioxide nanoparticles: it takes between 12 and 24 hours to dye the layer of titanium dioxide necessary for solar cell applications. Another major difficulty with the DSSC is the electrolyte solution: the cells must be carefully sealed in order to prevent liquid electrolyte leakage and therefore cell deterioration.

There is thus a need to prepare robust solar cells that can be prepared rapidly at reduced cost.

### SUMMARY OF THE INVENTION

It is an objective of the present invention to reduce the temperature necessary for sintering the metal oxide paste coating the electrode of dye-sensitised solar cells.

It is another objective of the present invention to leave the surface of the electrode free of any organic matter and ready for dye sensitisation.

It is another objective of the present invention that metal oxide photo-electrode sintering can be carried out at low temperature using metal oxide containing colloids which contain long chain organic polymers as binders.

It is also an objective of the present invention that the metal peroxides which are added as oxidation/combustion promoters are solids and thus easy to handle.

It is yet another objective of the present invention to use metal oxides having metal oxides as degradation products, said metal oxides being compatible with the metal oxide electrodes.

It is also an objective of the present invention to improve the device's performance thanks to the metal oxide degradation products which are photo-active.

Some or all of these objectives are realised in embodiments of the invention.

The present invention is defined in the independent claims. Preferred embodiments are defined in the dependent claims.

### BRIEF DESCRIPTION OF THE DRAWINGS

FIG. 1 is a schematic representation of a dye-sensitised solar cell.

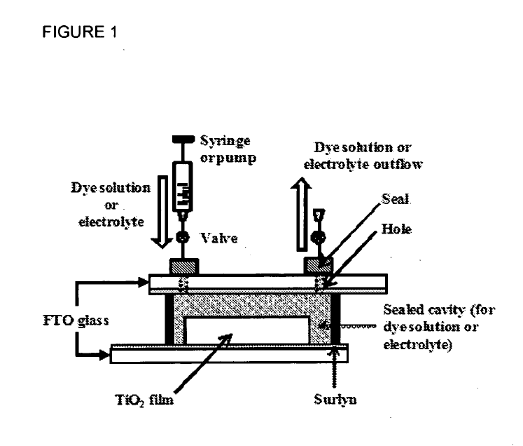

### DESCRIPTION OF THE PREFERRED EMBODIMENT

The present invention discloses a method for reducing the sintering temperature of a dye sensitised solar cell consisting of providing metal peroxide as a component of a metal oxide paste composition to be coated to the electrode of the cell.

The present invention discloses a method for reducing the sintering temperature of dye sensitised solar cells by adding metal peroxide to the colloid composition coating the electrode.

It discloses a method for reducing the sintering temperature of dye sensitised solar cells that comprises the steps of:

a) providing an electrode prepared from an electro-conducting substrate;
b) optionally pre-treating the electro-conducting substrate of step a) to ensure good adhesion of the metal oxide film;
c) preparing a colloid composition comprising at least one metal oxide, a solvent, optionally an adhesion agent and optionally at least one binder which consists of a long chain organic polymer;
d) adding to the colloid composition of step c) from more than zero wt % up to 100% wt, based on the weight of the colloid composition, of a solid metal peroxide;
e) applying the composition of step d) to the electrode;
f) either heating the coated electrode of step e) to a temperature of at most 300° C. for sintering the metal oxide followed by cooling to a temperature between room temperature and a temperature of between room temperature and 120° C. (preferably to a temperature of about 100° C.) or heating the coated electrode of step e) to a temperature of at most 200° C. and then exposing this heated electrode with UV-visible;
g) optionally post-treating the metal oxide film of step f) either with TiCl₄ solution and re-sintering to a temperature of at most, 300° C., followed by cooling to a temperature between room temperature and a temperature of between room temperature and 120° C. (preferably to a temperature of about 100° C.), or post-treating the metal oxide film of step f) with TiCl₄ solution and re-sintering to a temperature of at most, 200° C., followed by UV exposure and cooling to a temperature between room temperature and a temperature of between room temperature and 120° C. (preferably to a temperature of about 100° C.);
j) retrieving the electrode of either step g) or step i) coated with sintered metal oxide;
said method being characterised in that the peroxide added in step d) undergoes decomposition initiated thermally or photo-chemically, releasing highly reactive oxygen species within the metal oxide film.

Sintering is an important step in the preparation of dye-sensitised solar cells. It ensures that the metal oxide particles adhere to each other thereby efficiently carrying current and that they adhere strongly to the electrode substrate. Sintering also ensures complete removal of the organic binder and solvent present in the metal oxide colloid paste thereby increasing the porosity of the metal oxide film. It also helps to prepare the metal oxide surface for successful dye sensitisation. It is essential that both water and binder are removed during sintering to produce a “clean” metal oxide surface for dyeing. If carbonaceous material remains within the metal oxide film, insufficient dye is adsorbed by the metal oxide film, resulting in poor device efficiency. Metal oxide colloids also serve the double purpose of applying metal oxide to the electro-conducting substrate by screen-printing or doctor blading techniques and of ensuring that the film does not collapse after application.

The metal oxide colloid is suitably a paste of nanoparticles preferably prepared from a colloidal solution of metal oxide. The electronic contact between the particles is produced by sintering. Said sintering was typically carried out in the prior art by thermal treatment at a temperature of 450° C. to 600° C. for a period of time of at least 30 minutes. In the present invention, a pre-treatment step may be included to improve adhesion of the metal oxide film to the electro-conducting substrate. Sintering is then carried out at a temperature of at most 300° C. by thermal heating or of at most 200° C. if followed by UV-visible light exposure. The thermal treatment is followed by cooling, down to a temperature between room temperature and a temperature of between room temperature and 120° C. The metal oxide film is then ready for dyeing. This can be optionally followed by a post-treatment step whereby the metal oxide film is exposed to a solution of TiCl₄ followed by re-sintering at a temperature of at most 300° C., preferably of at most 290° C. followed by cooling as in the previous treatment. Such additional treatment is preferably present because it improves the efficiency of the solar cell. The size of the particles and pores making up the film is determined by the metal oxide particles' size and by the choice of binder and solvent used in the colloidal solution and also by the ratio oxide/binder/solvent. The internal surface of the film is an important parameter, also determined by the particles' size and by the film's thickness. The best combination of parameters depends upon the nature of the components used in the mixture and therefore upon the viscosity of the paste. Ideally, the viscosity is selected to allow the metal oxide film to be tipped without running and it must be sufficient to be doctor bladed or screen printed. The pore size must be large enough to allow easy diffusion and percolation of the electrolyte. The metal oxide particle sizes preferably range from 10 nm to 30 nm, preferably from 12 nm to 20 nm. The final film thickness preferably ranges from 5 μm to 20 μm, preferably from 7 μm to 15 μm. The amount of titanium dioxide in the composition preferably ranges between 0 and 30 wt %; most typically between 8 and 25% based on the total weight of the paste.

The solvent mixed with the metal oxide paste can be selected from alcohols such as ethanol or propanol or terpineol. Preferably it is terpineol. If the solvent is terpineol, it is added in an amount of at least 200 wt %, preferably at least 300 wt %, up to 400 wt %, most preferably about 350 wt %, based on the weight of the metal oxide paste. The addition of ethanol or another alcohol (or other suitable solvent) improves mixing. The metal oxide paste is suitably very viscous and cannot be stirred easily. The added ethanol (or other solvent) is removed at the end of the process. Typically, water is also added in an amount of at least 20 wt %, preferably at least 30 wt %, up to 40 wt %, most preferably 35 wt %, based on the total weight of the metal oxide paste. The ethanol (or other suitable solvent) and water are removed after mixing by heating to a temperature of up to 100° C. under a vacuum of about 10⁻² mm Hg.

The binder mixed with the metal oxide paste is a suitably long chain polymer selected for example from polyethylene glycol, polyvinyl alcohol or ethyl cellulose, preferably it is polyethylene glycol. The binder serves several purposes. It stabilises and thickens the colloid solution thereby preventing it from collapsing and running when it is spread on the electrode. It is also believed to help to provide porosity to the metal oxide paste, thereby favouring and improving percolation of the dye through the metal oxide paste. Suitably it is added in an amount of at least 20 wt %, preferably at least 30 wt %, up to 40 wt %, most preferably about 32 wt %, based on the weight of the metal oxide paste.

The solvent and binder are suitably added to the metal oxide and the mixture is stirred for several hours, homogenised for several minutes and sonicated for several minutes at room temperature to ensure homogeneous mixing of all components.

The adhesion agent can include calcium oxide or calcium hydroxide or polyvinyl alcohol and/or a flocculating agent such as polyacrylamide or polyacrylic acid. The adhesion agent is added to aid the adhesion of titania particles to each other within the film but also to aid adhesion of the titania nanoparticles to the electro-conducting substrate. The adhesion agent is preferably added to the paste. If present, the sintering temperature can be further reduced without reducing the adhesion of metal oxide particles to one another and to the substrate.

The solid metal peroxide added to or provided in the metal oxide colloid paste can be any known metal peroxide. It is preferably solid. H₂O₂ could be used but it presents the double disadvantage of being unstable, as it releases oxygen too easily, and of being highly explosive. Several metals of groups 2 and 12 of the Periodic table have been successfully tested. The preferred metals are Ca, Mg and Zn. More preferably it is Zn as zinc peroxide reacts to produce ZnO which has a conduction band in a position very similar to that of TiO₂, resulting in improved cell efficiency. Suitably the metal peroxide is used in an amount up to 25 wt %, based on the total weight of the metal oxide paste, preferably up to 20 wt %, suitably up to 15 wt %. Suitably the metal peroxide is used in an amount of from 0.2 wt %, based on the total weight of the metal oxide paste, preferably from 0.5 wt %, preferably from 0.9 wt %. It may be used in an amount from 2 wt %, or from 5 wt %. These reactive species have the technical effect of facilitating combustion of organic material within the colloid at lower temperature than would otherwise be possible.

The metal peroxide decomposes to release highly reactive oxygen species and metal oxides which can have an additional benefit to DSC device performance by adsorbing dye and accepting injected electrons in the same manner as titania particles.

This decomposition can take place thermally and/or can take place by exposure to UV light. This further improves subsequent device performance and also allows lower temperature sintering than using heat alone.

It is observed that there is a difference in the adhesion of films depending upon the direction of heating. Films heated predominantly from above using a furnace adhere better than those heated predominantly from below using a hotplate.

Optionally the electrode of step a) can be pre-treated with a metal oxide precursor, preferably selected from TiCl₄ or titanium isopropoxide to create a very thin film of titania on the substrate surface to reduce any recombination effects of electrolyte interacting with the working electrode substrate.

Optionally a titania precursor can be added to the colloid metal oxide paste. It is an aqueous suspension of titanium oxide particles which can be prepared from a titanium oxide precursor selected from a soluble titanium species such as but not limited to titanium isopropoxide or titanium tetrachloride which has been added to nitric acid in an amount of the order of 0 to 20% relative to the amount of water in a method known in the prior art. It can be used in place of water to be mixed with the metal oxide paste in order to form an aqueous colloidal dispersion. It is added in an amount of at least 300 wt %, preferably at least 350 wt %, up to 500 wt %, most preferably about 400 wt %, based on the weight of the metal oxide paste. It has the technical effect of providing an additional source of titanium oxide which can help to sinter the existing titanium dioxide particles together to improve photo-electrode performance.

Optionally, a thermal sintering agent and/or a chemical sintering agent can be added to the metal oxide paste to further reduce the sintering temperature.

The components of the paste can be added in any order. Conveniently, they may be added together, and co-mixed. Alternatively the components minus the solid metal peroxide may be brought together and mixed until the composition has the required properties, then the solid metal peroxide blended in. Other mixing methods are possible.

The optional thermal sintering agent mixed with the metal oxide paste is selected from another oxide such as manganese oxide, vanadium oxide, barium oxide, niobium oxide or cerium oxide. It is added in an amount of more than zero, preferably at least 1 wt %, more preferably at least 5 wt % and up to 20 wt %, preferably up to 15 wt %, and more preferably up to 10 wt %, based on the total weight of the metal oxide. The thermal catalyst operates during the heating taking place during the sintering cycle.

The optional chemical sintering agent chemical is selected from a fluoride-based material such as but not limited to an aqueous solution of hexafluorotitanic acid, or hexafluorozirconic acid or hydrogen fluoride, or ammonium fluoride or ammonium bifluoride or a mixture thereof. The chemical sintering agent is added in an amount of more than zero, preferably at least 1 vol %, more preferably at least 2 vol % and up to 10 vol %, preferably up to 5 vol %, and more preferably up to 3 vol %, based on the volume of water. The chemical sintering agent has the technical effect of dissolving the surface of metal oxide particles and allowing them to stick together thereafter in an etch deposition process.

After application of the colloid, suitably the metal oxide film is first sintered at a temperature ranging between 250 and 300° C. In some embodiments and in certain equipment this may be for a period of time ranging between 20 minutes and one hour, preferably about 30 minutes.

The metal peroxide decomposition releasing highly reactive oxygen species is carried out thermally and/or by exposure to UV light. This can further improve subsequent device performance and can also allow lower temperature sintering than using heat alone.

The sintering can optionally, but preferably, be followed by a treatment with titanium tetrachloride, itself followed by a second sintering cycle at a temperature ranging between 250 and 300° C. and cooling preferably to a temperature of about 100° C.

After the one or two sintering cycles, the films can be exposed to electro-magnetic radiation from a light source having a significant proportion of radiation with wavelengths of less than 410 nm; typically referred to as ultra-violet or UV light. Either continuous exposure or exposure to flashes of light are effective in preparing the metal oxide surface for subsequent dye uptake. However, the effect of increasing power of the light source is to reduce the required exposure time whilst the use of exposure to flashes of light can reduce any over-heating effects on the working electrode substrate.

There is a difference in the adhesion of films depending on the direction of heating. Films heated predominantly from above using a furnace adhered better than those heated predominantly from below using a hotplate. This is ascribed to differences in the loss of solvent and gaseous products of combustion with heating from underneath interfering with the creation of an effective interface between the metal oxide film and the substrate.

Preferably the sintering takes place by conveying the substrate through an oven, preferably for a relatively short residence time. The substrate may experience a range of temperatures, from room temperature when it enters the oven, up to an elevated temperature; which may be equal to the oven temperature, but is not necessarily equal to it.

Preferably the oven temperature, in such an embodiment in which the substrate is conveyed through the oven, it not greater than 450° C., preferably not greater than 400° C., preferably not greater than 350° C., preferably not greater than 300° C. In an embodiment which employs UV-exposure as described above, the oven temperature may be not greater than 250° C., preferably not greater than 200° C.

The residence time, by which we mean the time for which the substrate is in the oven, is preferably not greater than 10 minutes, preferably not greater than 8 minutes, preferably not greater than 6 minutes, preferably not greater than 4 minutes; and preferably not greater than 2 minutes.

The reduction of sintering temperature further allows the selection of substrates, not available when high sintering temperature is required, such as for example plastics or metals. When high sintering temperature is required glass substrate is the only available option. In the present invention, plastic substrate can be selected: it offers the advantages of being flexible and transparent thereby allowing both direct and reverse illumination. Metal substrate can also be selected: it offers the advantages of being flexible and lightweight, but it only allows reverse illumination.

Another important advantage of the present invention is the low level of organic material remaining in the film. Pure white films absorb dyes efficiently; generally the whiter the metal oxide film, the less organic matter it contains and the more effectively it adsorbs sensitising dye and the more efficient the resulting DSC device is. By comparison, remaining organic material gives the films a brownish coloration: the higher the organic material content, the stronger the coloration. The colour of the films prepared according to the present invention is systematically lighter than that of prior art films. The purity of the final film increases with increasing sintering temperature. In the films according to the present invention, sintered at a temperature of at most 300° C., the amount of remaining organic material is of less than 5 wt %, based on the weight of the film. Preferably it is ranges between 0 and 3 wt %.

We have found, unexpectedly, that the metal peroxide can be selected to promote or assist the removal of the binder. A metal peroxide which decomposes, to release reactive oxygen species, at a temperature at or reasonably close to the temperature at which the binder decomposes (combusts), can promote the latter reaction. It may initiate binder decomposition at a lower temperature; and/or it may speed the rate of binder decomposition. It may also drive the decomposition reaction nearer to completion, thereby reducing the amount of the aforementioned remaining organic material.

Suitably, in the method of the present invention the metal peroxide and the binder are selected so that the decomposition of the former under the sintering conditions assists the decomposition (combustion) of the binder.

If the maximum rate of decomposition of the metal peroxide is at temperature T¹; and the maximum rate of decomposition of the binder is at temperature T²; T¹ and T² are preferably within 80° C. of each other; preferably within 60° C. of each other; preferably within 50° C. or each other; preferably within 40° C. of each other.

Preferred binders for use in this invention decompose at relatively low temperatures, being organic compounds. Zinc peroxide is a preferred metal oxide because it decomposes at a relatively low temperature. Calcium peroxide and magnesium peroxide have decomposition temperatures which are higher than zinc peroxide, but still usefully low.

In preferred embodiments according to the present invention, the method for preparing dye sensitised solar cells can further be improved by using the fast dyeing process described in WO2010/089236 and/or the low platinisation temperature process described in WO2011/026812.

The present invention also discloses dye-sensitised solar cells obtained using the low temperature sintering method according to the present invention.

Solar panels can then be prepared by connecting individual solar cells prepared according to the present invention in the same or different colours.

In accordance with a further aspect there is provided the use for the purposes of facilitating the removal of a binder from a binder-metal oxide-solvent paste composition applied onto an electro-conducting substrate, of a metal peroxide; wherein the rate of decomposition of the metal peroxide is at its maximum at a first temperature T¹; wherein the rate of decomposition of the binder is at its maximum at a second temperature T²; and wherein T¹ and T² are within 80° C. of each other.

In accordance with a further aspect of the present invention there is provided the use of a metal peroxide in a metal oxide-containing composition, for the purpose of reducing the sintering temperature required to form a viable coating thereof on an electro-conductive substrate.

In accordance with a further aspect of the present invention there is provided the use of a metal peroxide in a metal oxide-containing composition which is applied as a coating to an electro-conductive substrate, sintered, and wherein the coating is loaded with a sensitising dye to form a solar cell; the use of the peroxide being for the purpose of achieving an improved short-circuit current value (J_{sc}) of the solar cell.

In relation to each of the ‘use’ aspects stated above, the statements of preferred features given above (for example, but not limited to, preferred metal peroxides, binders, amounts, sintering temperatures, etcetera) apply.

### EXAMPLES

### Preparation of Metal Oxide Screen-Printing Pastes

Screen-printing paste was made by slowly adding ethyl cellulose (8 g, Fluka) to terpineol (64.9 g, Fluka) at room temperature before stirring overnight to ensure complete dissolution. Then titanium dioxide P25 (Degussa) was added slowly to create a paste which was dispersed with a homogeniser to create a final paste containing 18% TiO₂, 9% ethyl cellulose and 73% terpineol. For the peroxide-containing pastes, either calcium peroxide or magnesium peroxide or zinc peroxide (Aldrich) were added to the titanium dioxide paste at concentrations respectively of 5 wt %, 10 wt % or 15 wt %, based on the total weight of the paste. The components were then thoroughly mixed to give a homogeneous paste.

### Device Manufacture.

For the working electrode, conductive glass (TEC-15, Pilkington—7 cm×2.5 cm) was washed with detergent and de-ionised water before placing in an ultrasonic bath in ethanol for 15 minutes followed by sequential rinsing with acetone and isopropanol and finally drying with N₂. A metal oxide paste prepared hereabove and containing 5 w t % metal peroxide was then printed onto the conductive side of the glass using doctor blade method with the layer thickness defined by a Scotch Tape™ spacer and allowed to dry for a period of time of 10 minutes at a temperature of 120° C. The resulting metal oxide film electrodes were sintered at a temperature of either at most 200° C., 300° C. or 450° C. for a period of time of 30 minutes with a ramp rate of 10° C./min from ambient to dwell temperature (200° C., 300° C. or 450° C.) using an furnace (Carbolite) or a hotplate (Dyesol) and optionally exposed to electromagnetic radiation containing a significant proportion of light with wavelengths <410 nm; commonly known as ultra-violet or UV light. After calcination, the films were removed when the temperature of the furnace or hot plate had reduced to a temperature of 80-100° C. Finally, the glass substrates (7.5 cm×2.5 cm) were cut into smaller pieces (2.5 cm×1.5 cm) and the metal oxide films adjusted to a surface of 2 cm×0.5 cm. The films were then immersed in an aqueous solution of TiCl₄:THF₂ (40 mM, Aldrich) for a period of time of 30 minutes at a temperature of 70° C. They were then re-sintered at a temperature of either at most 200° C., 300° C. or 450° C. for a period of time of 30 minutes and optionally re-exposed to UV light as described above. The resulting electrodes were immediately immersed in a mixed solution of acetonitrile and tert-butanol (1:1 v/v) containing cis-bis(2,2′-bipyridyl-4,4′-dicarboxylato)-ruthenium(II)-bis-tetra butylammonium (0.5 mM, N719, Dyesol) at room temperature overnight before rinsing with ethanol and drying with N₂. For the counter electrode, the conductive side of the glass was coated with an aqueous solution of 1-12 PtCl₆ (40 μL of 5 mM, Aldrich) and the electrodes were sintered at a temperature of 400° C. for a period of time of 30 minutes. The devices were then assembled by first placing a Surlyn™ (30 μm, DuPont) gasket around the TiO₂ photo-electrode and then placing the platinised counter electrode on top and sealing at a temperature of 120° C. with gentle pressure for a period of time of 2 minutes. An acetonitrile electrolyte solution containing LiI (0.1 M), I2 (0.05M), (0.5M), 1,2-dimethyl-3-propyl imidazolium iodide (0.5 M) and 4-tert-butylpyridine (0.5 M) was added through a fill hole in the counter electrode which was then sealed using Surlyn and a glass cover slip. Finally, prior to the sensitisation procedures described below, contacts were made onto the working and counter electrodes using conductive silver paint (Agar).

### Device Testing.

Current-voltage characteristics were measured using a Universal Photovoltaic Testing System (UPTS, Dyesol) at 100 mW cm⁻² or 1 Sun between 0 and 1 V. Lamps were calibrated to 1 Sun (100 mW cm⁻²) using a certified (Oriel 91150V) monocrystalline silicon reference cell traceable to the National Renewable Energy Laboratory (NREL).

### ABBREVIATIONS

In the tables below:

η is transfer efficiency
FF is fill factor or Curve Factor
V_{oc} is open circuit voltage
J_{sc} is short circuit current

### Example 1 (Comparative)

### P25 Devices Dyed with N719

DSC devices were prepared using a paste as described under ‘Preparation of metal oxide screen printing pastes’, (containing Degussa P25 titania but no metal peroxide, and sintered at a temperature of 450° C. either with or without treatment with TiCl₄ solution. Three devices were prepared in each case and the data are shown in Table 1.

TABLE 1

| Device | Temp/° C. | η/% | FF | V_{OC}/V | J_{SC}/mA cm⁻² |
|---|---|---|---|---|---|
| P25 | 450 | 2.84 | 0.61 | 0.70 | 6.60 |
| | | 2.87 | 0.60 | 0.79 | 6.02 |
| | | 2.59 | 0.52 | 0.75 | 6.04 |
| | Average | 2.8 | 0.58 | 0.75 | 6.22 |
| P25 + TiCl₄ | 450 | 3.09 | 0.57 | 0.71 | 7.73 |
| | | 3.36 | 0.62 | 0.76 | 7.14 |
| | | 3.23 | 0.54 | 0.77 | 6.97 |
| | Average | 3.2 | 0.58 | 0.74 | 7.28 |

It can be seen that in all cases, treatment with TiCl₄ and re-sintering improved the device's efficiency.

### Example 2

### P25-Peroxide Devices Sintered at 450° C. and Dyed with N719

DSC devices were prepared using a paste as described above under ‘Preparation of metal oxide screen printing pastes’ containing Degussa P25 titania along with either calcium peroxide, magnesium peroxide or zinc peroxide and sintered at a temperature of 450° C. All films were also treated with TiCl₄ solution and re-sintered at a temperature of 450° C. Five devices were prepared in each case and the data are displayed in Table 2.

TABLE 2

| Device | Temp/° C. | η/% | FF | V_{OC}/V | J_{SC}/mA cm⁻² |
|---|---|---|---|---|---|
| P25/CaO₂ + | 450 | 3.36 | 0.59 | 0.79 | 7.17 |
| TiCl₄ | | 3.41 | 0.62 | 0.77 | 6.47 |
| | | 3.21 | 0.63 | 0.81 | 5.99 |
| | | 3.36 | 0.62 | 0.750 | 6.60 |
| | | 3.31 | 0.66 | 0.79 | 6.29 |
| | Average | 3.3 | 0.62 | 0.78 | 6.51 |
| P25/MgO₂ + | 450 | 3.48 | 0.51 | 0.73 | 9.41 |
| TiCl₄ | | 3.66 | 0.61 | 0.79 | 7.56 |
| | | 3.45 | 0.61 | 0.80 | 7.21 |
| | | 3.50 | 0.57 | 0.79 | 7.85 |
| | | 3.57 | 0.57 | 0.79 | 7.92 |
| | Average | 3.5 | 0.57 | 0.78 | 7.99 |
| P25/ZnO₂ + | 450 | 4.07 | 0.60 | 0.76 | 8.86 |
| TiCl₄ | | 3.79 | 0.61 | 0.79 | 7.92 |
| | | 3.69 | 0.60 | 0.76 | 8.04 |
| | | 3.74 | 0.57 | 0.79 | 8.31 |
| | | 4.02 | 0.60 | 0.78 | 8.54 |
| | Average | 3.9 | 0.60 | 0.77 | 8.33 |

It is observed that for all the cases studied, at identical sintering temperature, the addition of metal peroxide improved the device's efficiency.

Zinc peroxide had the best efficiency. Without wishing to be bound by a theory, it is believed that zinc peroxide decomposes to oxygen and zinc oxide. Zinc oxide happens to have a conduction band very close to that of titanium dioxide and thereby efficiently contributes to improving the cell's performance.

### Example 3

### P25-Peroxide Devices Sintered at 300° C. and Dyed with N719

DSC devices were prepared using a paste as described above under ‘Preparation of metal oxide screen printing pastes’ containing Degussa P25 titania along with either calcium peroxide, magnesium peroxide or zinc peroxide and sintered at a temperature of 300° C. All films were also treated with TiCl₄ solution and re-sintered at a temperature of 300° C. Five devices were prepared in each case and the data are shown in Table 3.

TABLE 3

| Device | Temp/° C. | η/% | FF | V_{OC}/V | J_{SC}/mA cm⁻² |
|---|---|---|---|---|---|
| P25/CaO₂ + TiCl₄ | 300 | 2.26 | 0.56 | 0.71 | 5.63 |
| | | 2.20 | 0.63 | 0.71 | 4.93 |
| | | 2.20 | 0.59 | 0.76 | 4.93 |
| | | 2.38 | 0.61 | 0.76 | 5.15 |
| | | 2.25 | 0.60 | 0.76 | 4.97 |
| | Average | 2.3 | 0.60 | 0.74 | 5.12 |
| P25/MgO₂ + TiCl₄ | 300 | 2.64 | 0.63 | 0.75 | 5.57 |
| | | 2.62 | 0.66 | 0.76 | 4.73 |
| | | 2.51 | 0.58 | 0.75 | 4.29 |
| | | 2.81 | 0.64 | 0.75 | 5.21 |
| | | 2.67 | 0.54 | 0.72 | 4.17 |
| | Average | 2.7 | 0.54 | 0.75 | 4.79 |
| P25/ZnO₂ + TiCl₄ | 300 | 3.40 | 0.58 | 0.76 | 7.32 |
| | | 3.76 | 0.56 | 0.77 | 5.20 |
| | | 3.04 | 0.60 | 0.76 | 6.71 |
| | | 2.98 | 0.60 | 0.76 | 6.56 |
| | | 3.05 | 0.61 | 0.76 | 6.59 |
| | Average | 3.2 | 0.59 | 0.76 | 6.48 |

It is observed that sintering at a temperature of 300° C. a paste containing a metal peroxide gives efficiency results comparable to those of cells prepared without metal peroxide and sintered at a temperature of 450° C.

### Example 4 (Comparative)

### P25 Devices Sintered at 300° C. and Dyed with N719

DSC devices were prepared using a paste as described above under ‘Preparation of metal oxide screen printing pastes’ containing Degussa P25 titania but no metal peroxide and sintered at a temperature of 300° C. The films were also treated with or without TiCl₄ solution and re-sintered at a temperature of 300° C. The data are shown in Table 4.

TABLE 4

| Device | Temp/° C. | η/% | FF | V_{OC}/V | J_{SC}/mA cm⁻² |
|---|---|---|---|---|---|
| P25 | 300 | 0.00 | 0.34 | 0.02 | 0.20 |
| P25 + TiCl₄ | 300 | 0.34 | 0.61 | 0.58 | 0.82 |

These cells had no efficiency.

### Example 5

### Metal Oxide Films UV and Thermally Treated

DSC devices were prepared using a paste as described above under ‘Preparation of metal oxide screen printing pastes’ containing Degussa P25 Mania along with either calcium peroxide, magnesium peroxide or zinc peroxide. The films were either dried at a temperature of 120° C. or sintered at temperatures ranging between 250 and 450° C., treated with TiCl₄ solution and re-sintered at the same temperature as the first sintering temperature. The films were then exposed to UV light (800 W bulb) for 2 hours. The DSC device performance data are shown in Table 5.

TABLE 5

| | | | | J_{SC}/ |
|---|---|---|---|---|
| Device | η/% | FF | V_{OC}/V | mA cm⁻² |
| 450° C. + 2 h UV | | | | |
| P25 + TiCl₄ | 3.4 | 0.58 | 0.85 | 6.14 |
| P25/CaO₂ + TiCl₄ | 2.6 | 0.60 | 0.83 | 5.25 |
| P25/MgO₂ + TiCl₄ | 3.1 | 0.59 | 0.86 | 6.15 |
| P25/ZnO₂ + TiCl₄ | 4.1 | 0.64 | 0.87 | 3.69 |
| 300° C. + 2 h UV | | | | |
| P25 + TiCl₄ | 2.4 | 0.65 | 0.81 | 4.55 |
| P25/CaO₂ + TiCl₄ | 3.7 | 0.55 | 0.80 | 8.38 |
| P25/MgO₂ + TiCl₄ | 3.8 | 0.55 | 0.82 | 8.38 |
| P25/ZnO₂ + TiCl₄ | 4.6 | 0.53 | 0.82 | 10.54 |
| 250° C. + 2 h UV | | | | |
| P25 + TiCl₄ | — | | | |
| P25/CaO₂ + TiCl₄ | 3.5 | 0.67 | 0.81 | 6.43 |
| P25/MgO₂ + TiCl₄ | 2.8 | 0.66 | 0.81 | 5.16 |
| P25/ZnO₂ + TiCl₄ | 2.9 | 0.66 | 0.81 | 5.37 |
| 2 h UV only | | | | |
| P25 + TiCl₄ | 2.0 | 0.71 | 0.86 | 3.31 |
| P25/CaO₂ + TiCl₄ | 1.2 | 0.55 | 0.85 | 2.50 |
| P25/MgO₂ + TiCl₄ | 1.4 | 0.63 | 0.86 | 2.54 |
| P25/ZnO₂ + TiCl₄ | 1.7 | 0.69 | 0.86 | 2.80 |

### Example 6

### Effect of Sintering Temperature on Film Colour

Metal oxide films were prepared on glass microscope slides using a paste as described above under ‘Preparation of metal oxide screen printing pastes’ containing either Degussa P25 titania and no metal peroxide; or Degussa P25 titania along with either calcium peroxide, magnesium peroxide or zinc peroxide. First the microscope slides were rinsed sequentially with acetone and isopropanol and dried with N₂. Then metal oxide paste was printed using the doctor-blade technique and the films were sintered at a range of temperatures between 200 and 300° C. After sintering, the colour of the film was examined. Brown films still contained organic material which had not either evaporated or combusted. This residue decreases the efficiency of dye sensitisation. Pure white films absorb dyes most successfully. The data are shown in Table 6.

TABLE 6

| | Time | Film colour after sintering | | | |
|---|---|---|---|---|---|
| Temp. (° C.) | (min) | P25 | P25/CaO₂ | P25/MgO₂ | P25/ZnO₂ |
| 200 | 30 | Brown | Brown | Brown | Brown |
| 250 | 30 | Brown | Brown | Brown | Brown |
| | | | (partially) | | |
| | 60 | Brown | Brown | Brown | Brown |
| | | | (partially) | | |
| | 90 | Brown | Brown | Brown | Brown |
| | | | (partially) | | |
| | 120 | Brown | Brown | Brown | Brown |
| | | | (partially) | | |
| 275 | 30 | Brown | White | White | White |
| | | | (almost) | (partially) | (partially) |
| | 60 | Brown | White | White | White |
| | | | (almost) | (partially) | (partially) |
| | 90 | Brown | White | White | White |
| | | | (almost) | (partially) | (partially) |
| | 120 | Brown | White | White | White |
| | | | (almost) | (partially) | (partially) |
| 300 | 30 | Brown | White | White | White |

### Further Work

Tests were also carried out using calcium peroxide, magnesium peroxide and zinc peroxide at concentrations of 10 wt % and 15 wt %, based on total weight of paste; the amounts of the other components being as stated in above under the heading ‘Preparation of metal oxide screen-printing pastes’. The resulting peroxide-containing pastes also had good rheology and sintering characteristics and produced devices with good efficiency when sintered at an oven temperature of 300° C. and treated with dye, as described above.

1. A method for reducing the sintering temperature of a dye sensitised solar cell, the method comprising: providing metal peroxide as a component of a metal oxide paste composition to be coated to an electrode of the cell.

2. The method of claim 1 for reducing the sintering temperature of dye sensitised solar cells that comprises the steps of:
a) providing an electrode prepared from an electro-conducting substrate;
b) preparing a colloid composition comprising at least one metal oxide, a solvent, optionally an adhesion agent and at least one binder;
c) adding to the colloid composition of step b) from more than zero wt % up to 100 wt %, based on the weight of the colloid composition, of a solid metal peroxide;
d) applying the composition of step c) to the electrode;
e) either heating the coated electrode of step d) to a temperature of at most 300° C. for sintering the metal oxide followed by cooling to a temperature in the range from room temperature to 120° C., or heating the coated electrode of step d) to a lower temperature of at most 200° C. and then exposing this electrode with UV-visible light;
f) retrieving the electrode coated with sintered metal oxide,
said method being characterised in that the peroxide added in step c) undergoes decomposition initiated thermally or photo-chemically, releasing highly reactive oxygen species and metal oxide within the metal oxide film.

3. The method of claim 1 wherein the binder is selected from polyethylene glycol, polyvinyl alcohol or ethyl cellulose, preferably ethyl cellulose.

4. The method of claim 1 wherein the binder is added in an amount of from 20 to 40 wt % with respect to the weight of the metal oxide paste.

5. The method of claim 1 wherein the rate of decomposition of the metal peroxide is at its maximum at a temperature T¹, and the rate of decomposition of the binder is at its maximum at a temperature T², wherein T¹ and T² are within 80° C. of each other.

6. The method of claim 1 wherein the metal peroxide is a solid metal peroxide.

7. The method of claim 6 wherein the solid metal peroxide is selected from calcium peroxide, magnesium peroxide or zinc peroxide.

8. The method of claim 1 wherein a thermal sintering agent is incorporated into the metal oxide paste, is selected from a metal oxide different from that used for coating the electrode, is selected from manganese oxide, vanadium oxide, niobium oxide, barium oxide or cerium oxide, and is added in an amount of about 10 wt %, based on the weight of the metal oxide.

9. The method of claim 1 wherein a chemical sintering agent selected from an aqueous solution of hexafluorotitanic acid, or hexafluorozirconic acid or hydrogen fluoride, or ammonium fluoride or ammonium bifluoride or a mixture thereof is added to the metal oxide paste in an amount of from more than zero vol % up to 10 vol %, based on the volume of the solvent.

10. The method of claim 1 wherein an adhesion agent is present and is selected from calcium oxide or calcium hydroxide or polyvinyl alcohol and/or a flocculating agent such as polyacrylamide or polyacrylic acid.

11. The method of claim 2 wherein the peroxide decomposition releasing highly reactive oxygen species is carried out thermally or by exposure to UV light or a combination thereof.

12. The method of claim 2 wherein the metal oxides released by the decomposition of metal peroxide improves the cell's efficiency by adsorbing dye and accepting injected electrons in the same manner as titania particles.

13. The method of claim 1 wherein the coated electrode is obtained by the method of etch deposition, screen printing or doctor blading onto the substrate.

14. Dye-sensitised solar cells prepared by the method of claim 1.

15. (canceled)

16. The method of claim 2, further comprising:
pre-treating the electro-conducting substrate of step a) to ensure good adhesion of the metal oxide film.

17. The method of claim 2, further comprising:
post-treating the metal oxide film of step e) with TiCl₄ solution and re-sintering to a temperature of at most, 300° C., followed to a temperature in the range from room temperature to 120° C., or post-treating the metal oxide film of step e) with TiCl₄ solution and re-sintering to a temperature of at most, 200° C., followed by UV exposure and cooling to a temperature in the range from room temperature to 120° C.
